(19) United States
(12) Patent Application Publication
(10) Pub. No.: US 2024/0044929 A1
(43) Pub. Date: Feb. 8, 2024

(54) MIXING HEATER SETPOINT CHANGE

(71) Applicant: Beckman Coulter, Inc., Brea, CA (US)

(72) Inventors: Noriyuki Ito, Shizuoka (JP); Yuichi Hasegawa, Shizuoka (JP)

(21) Appl. No.: 18/038,518

(22) PCT Filed: Nov. 30, 2021
(86) PCT No.: PCT/US21/61070

§ 371 Date: May 24, 2023

Related U.S. Application Data
(60) Provisional application No. 63/119,267, filed on Nov. 30, 2020.

(51) Int. Cl. G01N 35/10

(52) U.S. Cl. CPC G01N 35/10; G01N 2035/00534

(57) ABSTRACT

A chemistry analysis machine and method for using the machine include adding heating functionality to provide faster test specimen heating times or comparable specimen heating times while using containers or cuvettes made of materials such as plastic that have lower thermal conductivity. In one example, a mixing bar is heated prior to contacting the test specimen within the container to provide the additional heating capability to the system. In one example where the mixing bar is heated, a heater is added to the system to heat the rinse water used to rinse the mixing bar after it is washed and prior to its next use in contacting a test specimen.

### PRIORITY

This application claims priority to U.S. Provisional Patent Application Ser. No. 63/119,267, entitled “Mixing Heater Setpoint Change,” filed Nov. 30, 2020, the disclosure of which is incorporated by reference herein.

### BACKGROUND

Chemistry analysis of samples is used in various fields, including for example, the medical field. For instance, a sample obtained from a patient can be tested by itself, or combined with one or more reagents, and tested to determine the presence, absence, or amount of certain chemicals or substances within the sample. Various chemistry analyzers exist to facilitate such testing. Additionally, various processes or methods exist and have been used with such analyzers to conduct such testing. While a variety of devices, systems, and methods for clinical chemistry analysis have been made and used, it is believed that no one prior to the inventor(s) has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a perspective view of an exemplary chemistry analysis machine.

FIG. 2 depicts a plan view of an exemplary analysis section of the chemistry analysis machine of FIG. 1.

FIG. 3 depicts a perspective view of an exemplary sample probe assembly of the analysis section of FIG. 2, shown with a portion of the housing removed to reveal internal features.

FIG. 4 depicts a schematic side view of an exemplary probe and mixing rod of the sample probe assembly of FIG. 3, shown positioned within a container having a test specimen therein.

FIG. 5 depicts a block diagram of a process for use with the chemistry analyzer of FIG. 1.

FIG. 6 depicts an exemplary graph showing the time and temperature profile for exemplary container materials and heating processes usable with the chemistry analyzer of FIG. 1 and process of FIG. 5.

FIG. 7 depicts a block diagram of an exemplary architecture used for the chemistry analysis machine of FIG. 1.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### I. EXEMPLARY ANALYSIS MACHINE

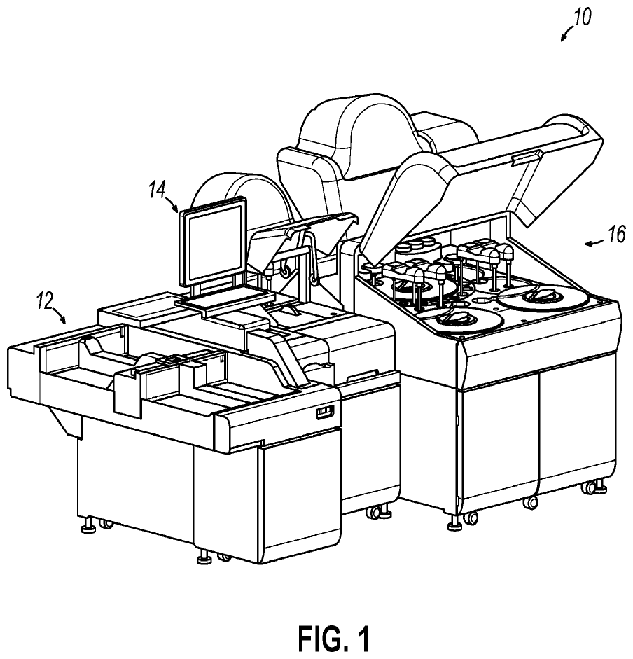

FIG. 1 illustrates an exemplary chemistry analysis machine (10) usable for clinical chemistry analysis. Analysis machine (10) comprises a collecting section (12) where racks containing sample containers may be located. Analysis machine (10) further comprises control and display section (14) where instructions for testing can be input into analysis machine (10) for executing by analysis machine (10). Also, at control and display section (14), testing progress, status, and/or results can be displayed. Analysis machine (10) further comprises one or more analysis sections (16) where samples are analyzed to determine at least one parameter or characteristic of the samples.

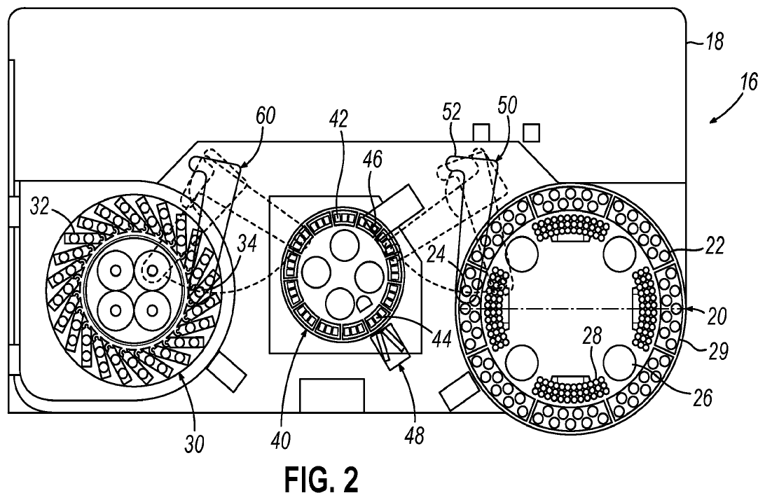

FIG. 2 depicts an exemplary plan view for analysis section (16). In the present example, each analysis section (16) is defined by a body or housing (18). It should be noted that the configuration depicted in FIG. 2 is exemplary only and that in other versions the configuration used with analysis section (16) may differ. Nonetheless, in the present example analysis section (16) comprises a sample station (20), a reagent station (30), and an analysis station (40).

Sample station (20) is configured to receive one or more containers (22) holding a sample to be tested or analyzed. Sample station (20) comprises an extraction site (24) where a portion of the sample can be removed from its container (22) for further preparation and testing as described below. Sample station (20) is further configured with one or more diluent containers (26) and one or more diluent sections (28) configured to contain dilution cups. The one or more containers (22) may be retained within a sample rack (29), which may be configured to retain and display coded information, e.g., in a bar code or QR code, etc. Of course, the one or more containers (22) themselves may, alternatively or in addition to rack (29), contain and display coded information. Sample station (20), or a portion of sample station (20), is movable, e.g., by rotation or otherwise, such that the one or more containers (22) can each be moved into and out of extraction site (24).

Reagent station (30) is configured to receive one or more containers (32) holding a reagent. Reagent station (30) comprises an extraction site (34) where a portion of the reagent can be removed from its container (32) for combining with a portion of the sample for further preparation and testing as described below. Reagent station (30), or a portion of reagent station (30), is movable, e.g., by rotation or otherwise, such that the one or more containers (32) can each be moved into and out of extraction site (34). Reagent station (30) can also include coded information, e.g., via bar codes or QR codes, applied to containers (32) or groups of containers (32) to convey information concerning the contents of the one or more containers (32).

Analysis station (40) is configured to contain one or more containers (42), which in the present example have the form of a cuvette made from glass or plastic. Containers (42) are configured to receive extracted amounts of the sample and/or the sample plus reagents. In accordance with instructions input to analysis machine (10) at control and display section (14) or provided in another manner, i.e., remotely via a network connection to another control device, analysis machine (10) is configured to prepare and analyze a test specimen (8), which is defined by the contents of containers (42). Analysis station (40) comprises an analyzing site (44) and a container washing site (46). Analyzing station (40) preferably comprises a movable member to move containers (42) from the analyzing site (44) to the washing site (46).

Analyzing station (40) is configured for operation at a prescribed temperature, which may be dictated by the particular operator or testing procedures. By way of example, and not limitation, in some instance it is preferable that analyzing station (40) is operated at or about 37 degrees Celsius. In this manner, analyzing station (40) comprises a heating feature (47), which in some examples is configured as a dry bath within analyzing station (40).

Analyzing station (40) further comprises an analyzer (48) located proximate to analyzing site (44) for determining at least one parameter of test specimen (8) contained within container (42). In some versions, analyzer (48) comprises a nephelometer and turbidimeter combination for measuring an amount of scattered light projected through containers (42). In other versions, analyzer (48) comprises other analysis devices or components as will be apparent to those of ordinary skill in the art in view of the teachings herein. Analyzing station (40) can also include calibration features that work with analyzer (48) to calibrate analyzer (48) as needed or desired.

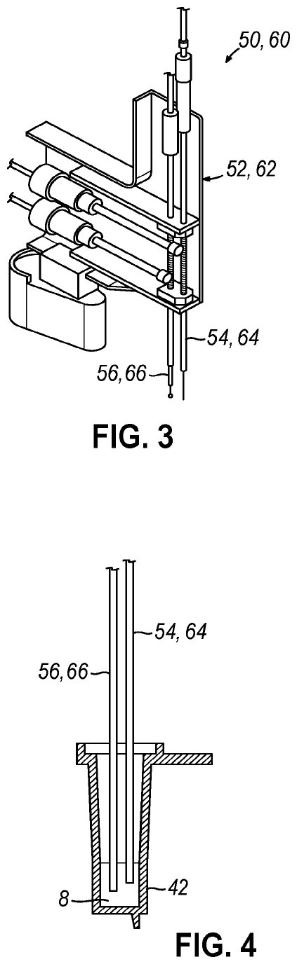

Analysis section (16) comprises a sample probe assembly (50) as shown in FIG. 2. Sample probe assembly (50) comprises a sample probe arm (52). Sample probe assembly (50) further comprises a sample probe (54) and a rotatable sample stirring rod or mixing bar (56), as shown in FIGS. 3 and 4. Sample probe (54) is configured to draw-in or take-up sample material as well as expel sample material from within sample probe (54). By way of example only, in one example sample probe (54) comprises a syringe. Sample probe (54) is also configured to move between a raised position and a lowered position. Similarly, mixing bar (56) is movable between a lowered position and a raised position, and as mentioned above, mixing bar (56) is rotatable to facilitate stirring or mixing within containers (22, 42). Analysis section (16) further comprises a reagent probe assembly (60) with similar construction as sample probe assembly (50) where reagent probe assembly includes a reagent probe arm, reagent probe, and a rotatable reagent stirring rod or mixing bar.

### II. EXEMPLARY METHOD OF USE

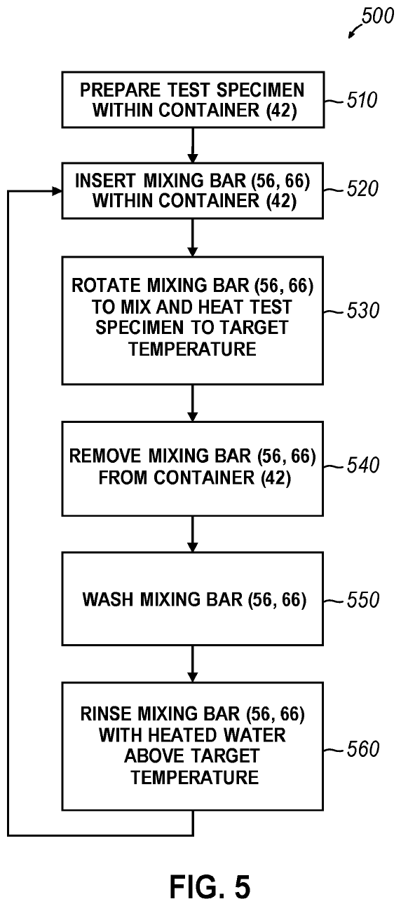

Referring to FIG. 5, an exemplary block diagram depicts a method (500) of using or operating chemistry analysis machine (10). At step (510), test specimen (8) is prepared within container (42). This involves a user of analysis machine (10) loading reagent station (30) with one or more reagent containers (32) containing premixed reagent. The user then loads sample station (20) with one or more sample containers (22) containing samples to be analyzed. The user then places diluent containers (26) and diluent section (28) in sample station (20).

Sample probe arm (52) moves sample probe (54) to a position above sample extraction site (24). Sample probe (54) is lowered from its raised position until sample probe (54) is below the surface of the sample within sample container (22) positioned at the sample extraction site (24). Sample within sample container (22) is then drawn into sample probe (54), and sample probe (54) is then moved to its raised position. Sample probe arm (52) then rotates to a position over one of the dilution cups where sample probe (54) is lowered and the sample within sample probe (54) is expelled or discharged into the dilution cup.

Sample probe arm (52) then rotates sample probe (54) to a position above one of diluent containers (26). Sample probe (54) is lowered from its raised position to a position below the surface of the diluent in diluent container (26), and diluent is drawn into sample probe (54). Sample probe (54) is then moved to its raised position and sample probe arm (52) rotates sample probe (54) to a position immediately above the dilution cup containing the sample as noted above. Sample probe (54) is then lowered into the dilution cup and expels or discharges the diluent out of sample probe (54) and into the dilution cup with the sample. Mixing bar (56) is then lowered into the dilution cup and rotated to mix the sample and the diluent.

Next, sample probe (54) is again lowered into the dilution cup and the diluent-sample mixture is drawn into sample probe (54). Sample probe arm (52) then rotates sample probe (54) to a position above container (42) and sample probe (54) is lowered into container (42), and the diluent-sample mixture is expelled from sample probe (54) into container (42). Immediately before or after these steps, reagent probe assembly (60) delivers a quantity of reagent to container (42).

With test specimen (8) within container (42), at step (520) mixing bar (56) is lowered into container (42). Thereafter, at step (530) mixing bar (56) is rotated to stir or mix test specimen (8) within container (42). As will be described further below, mixing bar (56) is heated to a temperature that exceeds the temperature of test specimen (8) such that as mixing bar (56) rotates to stir or mix test specimen (8), mixing bar (56) also heats test specimen (8) from its initial temperature to a predetermined temperature. Once test specimen (8) reaches the predetermined temperature, at step (540) mixing bar (56) is removed from container (42), and container (42) is moved within analysis section (16) to analyzing site (44) for analysis.

Meanwhile, at step (550), mixing bar (56) is washed to prepare it for use with a subsequent test specimen (8). Washing mixing bar (56) in the present example includes using a detergent or other cleaner to wash away any residual material from test specimen (8). At step (560), mixing bar (56) is rinsed with heated water at a target temperature such that the next time mixing bar (56) is used with another test specimen (8), mixing bar (56) is at an elevated temperature compared to the initial temperature of test specimen (8). In this manner, as described above, mixing bar (56) is configured not only to stir or mix test specimen (8) but also to heat the next test specimen (8) to a predetermined temperature.

In one example, analysis machine (10) uses containers (42) that are formed from a plastic material, while in another example containers (42) are made from glass. In either scenario, after a certain number of uses, scale and/or other deposits develop on containers (42) such that containers (42) require a thorough cleaning that goes beyond the automated washing sequence performed by analysis machine (10) after testing a test specimen within container (42). This thorough cleaning process may be manually performed and may occur at repeatable increments, e.g., every six months. However, when using a lower cost plastic material, such a periodic thorough cleaning process can be omitted in lieu of simply replacing containers (42) with new ones and either recycling or disposing the used ones.

Because plastic is a better insulator than glass, i.e., plastic has a lower thermal conductivity than glass, when using containers (42) made from plastic, a modification to the heating function is needed to raise the temperature of test specimen (8) within container (42) to the target or predetermined temperature for conducting the desired analysis within the same time period. For instance, in one example where heating feature (47) comprises a dry bath and is used with containers (42) made from plastic, containers (42) must remain exposed to the dry bath for a longer time to achieve the target temperature of test specimen (8) compared to when containers (42) are made from glass. This longer time has for heating negatively impacts throughput. In at least one example, it is desirable to heat test specimen (8) within container (42) to 37 degrees Celsius within two minutes. While a dry bath heating configuration for heater feature (47) has been able to achieve this with glass containers (42), the same result is not achieved in the same time when plastic containers (42) are used with the same heating application.

To avoid decreasing the throughput of analysis machine (10) by requiring longer heating times with the dry bath only system mentioned above, with respect to method (500), mixing bar (56) is heated, which thereby provides for heating test specimen (8) during mixing to the target or predetermined temperature. For instance, where the target or predetermined temperate is 37 degrees Celsius, mixing bar (56) is heated above that temperature so as to provide a heat source capable of raising the temperature of test specimen (8) to that target or predetermined temperature. Moreover, this heating of mixing bar (56) is configured to achieve heating of test specimen (8) without extending the standard or typical heating times such that the throughput of analysis machine (10) is not impacted negatively. By way of example only, and not limitation, mixing bar (56) is heated to between 39 and 42 degrees Celsius prior to step (520) of method (500) where mixing bar (56) is inserted within container (42). In this example, where container (42) is made of plastic, test specimen (8) is heated to 37 degrees Celsius within two minutes.

When method (500) is used with containers (42) made of glass, the heating times for heating test specimens (8) to the target temperature can be reduced. This reduction in heating time is seen because the heated mixing bar (56) is now an additional heat source or heating feature along with the dry bath heating feature. This reduction in heating times can provide for an increase in throughput of analysis machine (10). In some instances, this increased throughput offsets some or all of the added time required for thoroughly cleaning and reusing the glass containers (42).

The use of mixing bar (56) as an additional heating feature or heat source to the dry bath, also provides for the addition of a heating feature configured to heat test specimen (8) without constraint based on the material of container (42) holding test specimen (8). This is the case because mixing bar (56) directly contacts test specimen (8) within container (42) and thus is able to efficiently transfer energy in the form of heat to test specimen (8) without the thermal conductivity of container (42) negatively affecting the heating efficiency.

As mentioned above with respect to method (500), mixing bar (56) of chemistry analysis machine (10) repeats the following general sequence: (1) mixing, (2) washing, and (3) rinsing. With method (500) where mixing bar (56) comprises an additional heating feature, in step (560) of method (500), mixing bar (56) is heated by the water used in the rinsing step after the washing. For instance, with method (500), the incoming temperature of the water used for rinsing mixing bar (56) is increased to about 42 degrees Celsius. This increase in temperature can be compared to other dry bath only configurations where the rinse water is about 30 degrees Celsius. Therefore, with method (500), the water used to rinse mixing bar (56) is increased about 12 degrees Celsius.

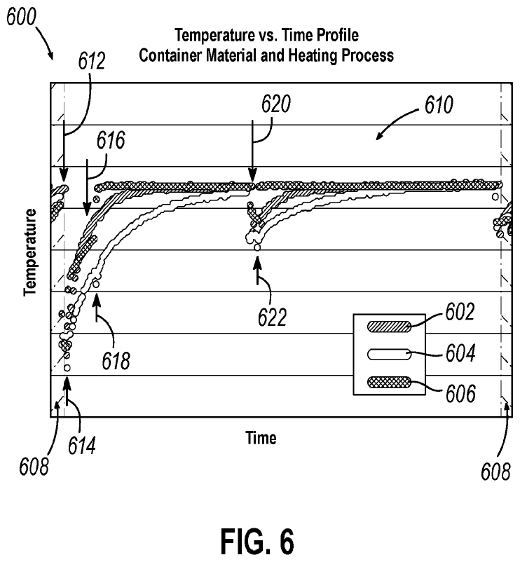

FIG. 6 depicts an exemplary graph (600) that shows the temperature response over time based on heating process and container (42) material variables. It should be noted that the illustration in FIG. 6 is merely one example and that the invention shall not be limited to what is illustrated in the example of FIG. 6. Graph (600) shows time along the x-axis or horizontal axis and temperature along the y-axis or vertical axis. In graph (600), washing stages (608) are shown at the beginning and end, with test specimen (8) preparation and heating stage (610) shown between washing stages (608).

Three data series are depicted in graph (600), with series (602) representing conditions using container (42) made of glass with a dry bath only heating process. Series (604) represents using container (42) made of plastic with a dry bath only heating process. Lastly, series (606) represents using container (42) made of plastic with a dry bath plus heated mixing bar (56). Immediately after the first washing stage (608) concludes, a reagent is dispensed into container (42) as indicated by (612) in graph (600). In some examples, this reagent may be a diluent. Thereafter, this reagent is mixed as indicated by (614). Shortly thereafter at (616), sample is dispensed into container (42), and thereafter sample is mixed at (618). The sample here could be a full-strength sample or a diluted sample. Next at (620) a second reagent is dispensed into container (42), and then mixed at (622). Again, in some examples this reagent may be a diluent.

During preparation and heating stage (610), the temperature increases across all data series until the second reagent is added at (620) at which point there is a decline in temperature signifying that the incoming temperature of the second reagent is lower than the mixture in container (42) at that point. Thereafter, the heating causes the temperature to again increases across all data series with the temperature increase leveling off as the target or predetermined temperature is reached. In comparing data series (604) with data series (602), only the dry bath heating is used, and the only difference is the construction material of container (42). With series (602) the glass container (42) heats more quickly than with series (604) for the plastic container (42). In comparing data series (604) with data series (606), the material of container (42) is plastic in both data series (604, 606), but the additional mixing bar (56) heat source is used with respect to data series (606). As illustrated, the time to reach a given temperature is lower for data series (606) compared to data series (604). Moreover, comparing data series (606) with data series (602) shows that using the additional mixing bar (56) heating feature with a plastic container (42) produces the same or better heating times compared to using a dry bath only heating feature with a glass container (42).

While the above description of method (500) of FIG. 5, focuses on mixing bar (56) of sample probe assembly (50) as providing the heating feature to test specimen (8), in other examples, reagent probe assembly (60) with reagent probe arm (62), reagent probe (64), and associated reagent stir rod or mixing bar (66) can provide such heating feature to test specimen (8) within container (42). In such examples, mixing bar (66) is configured and operable in the same manner as mixing bar (56) as described above. This may be instead of, or in addition to, heating provided by mixing bar (56). As mentioned above, in some applications, analysis machine (10) may be operated such that a reagent is added as the last step in preparing test specimen (8). In such instances, mixing bar (66) of reagent probe assembly (60) is in contact with test specimen (8) prior to test specimen (8) being moved within analysis machine (10) for testing. With this sequence using mixing bar (66) for additional heating as described above, saves time and process steps from needing to remove reagent probe assembly (60) and reinsert sample probe assembly (50) so that mixing bar (56) can provide heating. Accordingly, depending on the order of operations in preparing test specimen (8), either mixing bar (56, 66) or both mixing bars (56, 66) may be used to provide heating to test specimen (8) within container (42).

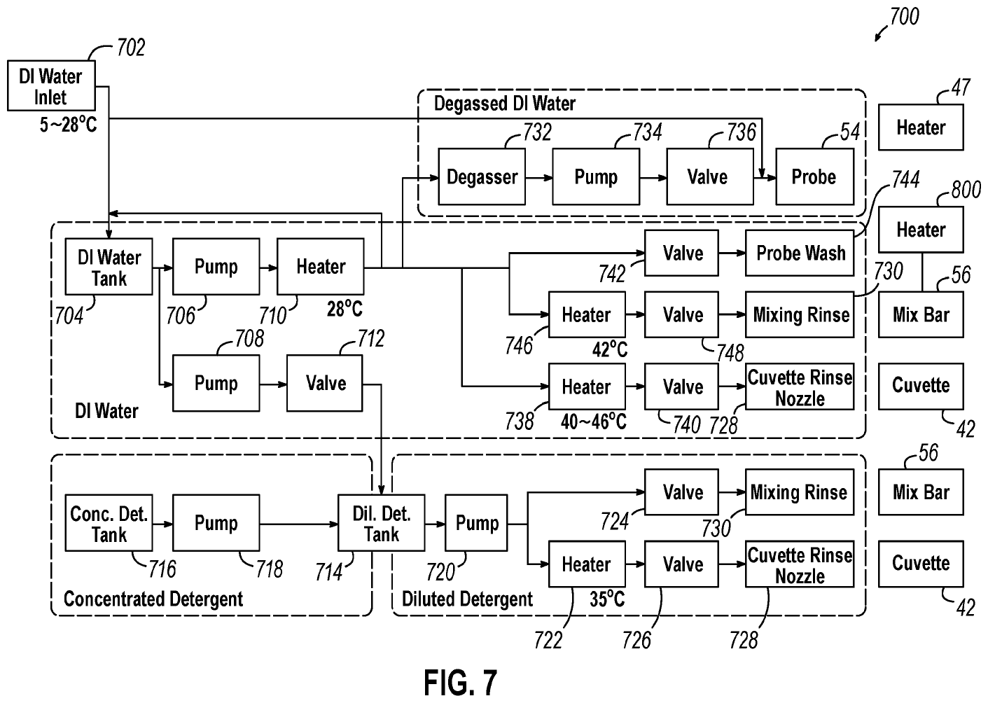

In some other versions of method (500), mixing bars (56, 66) are heated in other ways rather than via heated rinsing water. For example, either or both mixing bars (56, 66) may be heated by a source exposing mixing bars (56, 66) to heated air. In another example, either or both mixing bars (56, 66) may be heated by a source exposing mixing bars (56, 66) to a radiant heat source such as electrically heated coils. Still in another example, either or both mixing bars (56, 66) may be heated by electric resistance heating where mixing bars (56, 66) are connectable to an electrical current configured for heating mixing bars (56, 66). These alternate heating methods will be described further below with respect to FIG. 7 and the exemplary system architecture.

### III. EXEMPLARY SYSTEM ARCHITECTURE

FIG. 7 illustrates an exemplary block diagram of a system architecture (700) for chemistry analysis machine (10). In some instances, the diagram of system architecture (700) may be referred to as a piping diagram (700). A deionized water inlet (702) provides deionized water to a deionized water tank (704). The temperature of the deionized water at the inlet may be in the range of about 5 degrees Celsius to about 28 degrees Celsius. From deionized water tank (704), deionized water is pumped by pumps (706, 708), with pump (706) directing deionized water to a heater (710). Heater (710) is configured to heat the deionized water to at or about 28 degrees Celsius.

Meanwhile, pump (708) directs a flow of deionized water to a valve (712) that can be controlled to selectively direct deionized water to a diluted detergent tank (714) as part of a washing system. Upstream of diluted detergent tank (714) is a concentrated detergent tank (716) and a pump (718) configured to directed concentrated detergent to diluted detergent tank (714) where the concentrated detergent mixes with the deionized water from pump (708) by way of valve (712). From diluted detergent tank (714), a pump (720) directs diluted detergent to a heater (722) and separately to a valve (724). Heater (722) is configured to heat the diluted detergent to about 35 degrees Celsius, and thereafter the heated diluted detergent is directed to valve (726). Valve (726) is controllable to deliver heated diluted detergent to a container rinse nozzle (728). As mentioned above container (42) may be in the form of a cuvette and thus rinse nozzle (728) can also be considered cuvette rinse nozzle (728). In this manner, the heated diluted detergent is provided to wash container (42). Valve (724) is controllable to deliver diluted detergent to a mixing rinse (730). In this manner, the diluted detergent is provided to wash mixing bar (56) of sample probe assembly (50).

Returning to heater (710), from heater (710) there is a recirculation flow of deionized water that feeds to deionized water tank (704). There is also a flow of deionized water from heater (710) to a degasser (732) configured to remove entrained air from the deionized water. A pump (734) directs degassed deionized water from degasser (732) to a valve (736) configured to selectively direct degassed deionized water to sample probe (54). In some instances, deionized water from deionized water inlet (702) is directed directly to probe (54).

Another flow from heater (710) is directed to heater (738), which heats the deionized water further. From heater (738), the further heated deionized water is directed to a valve (740) that is controllable to selectively direct heated deionized water to container rinse nozzle (728). In this manner, the heated deionized water is provided to rinse container (42), which again may be in the form of a cuvette.

From heater (710), another flow of deionized water heated to about 28 degrees Celsius is directed to a valve (742). Valve (742) is controllable to selectively provide deionized water at about 28 degrees Celsius to a probe wash (744). In this manner, the deionized water is provided to rinse probe (54).

Lastly, from heater (710), another flow of deionized water at about 28 degrees Celsius is directed to a heater (746). Heater (746) is configured to heat the deionized water from 28 or about 28 degrees Celsius to 42 or about 42 degrees Celsius. Thereafter, this heated deionized water is directed to a valve (748) that is controllable to selectively provide deionized water at 42 or about 42 degrees Celsius to mixing rinse (730). In this manner, the heated deionized water is provided to rinse mixing bar (56). Furthermore, this heated deionized water also heats mixing bar (56) as described above such that during subsequent mixing of test specimen (8), test specimen (8) is heated during mixing by mixing bar (56). Again, as described above, this heating by mixing bar (56) provides for heating test specimens (8) within containers (42) to a target temperature within a prescribed time, irrespective if container (42) is made from plastic instead of glass.

Still referring to FIG. 7, system architecture (700) further includes heater (47) as mentioned above. In the present example, heater (47) is configured as a dry bath that heats containers (42) within analysis station (40) to heat test specimens (8) within containers (42). In other versions, heater (47) could be a wet bath, or circulating heated air. Still in another example of system architecture (700), an optional heater (800) is included that may be used instead of or in addition to heater (746). Heater (800) in one version is configured to expose mixing bar (56) to heated air to thereby raise the temperature of mixing bar (56). In another version, heater (800) comprises an electric resistance heater where mixing bar (56) is connectable to an electrical current configured for heating mixing bar (56). In view of the teachings herein, other configurations for heater (800) and ways to heat mixing bar (56) will be apparent to those of ordinary skill in the art.

As mentioned above, in some other versions mixing bar (66) of reagent probe assembly (60) may be configured for use in the same or similar manner as mixing bar (56) of sample probe assembly (50). In such instances, system architecture (700) can be adapted for use to heat mixing bar (66) instead or in addition to heating mixing bar (56). In view of the teachings herein, other modifications to architecture (700) will be apparent to those of ordinary skill in the art.

In some other exemplary methods and systems used with chemistry analysis machine (10), other techniques may be used to improving heating times and efficiency such that containers (42) made of plastic may be used to allow for periodic replacement of containers (42) instead of manual cleaning. For example, one such technique could be to employ ultrasonic mixing that has both mixing and heating effects. Still another option could be to employ a reagent probe heater where the temperature of the reagent is increased when the reagent is transferred to container (42). Again, in view of the teachings herein, other modifications to the systems and methods described above will be apparent to those of ordinary skill in the art.

### IV. EXEMPLARY COMBINATIONS

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A device for determining at least one parameter of a liquid sample comprises a body having a sample station and an analysis station disposed within the body. The sample station is configured to receive a container holding the liquid sample. The device further comprises a connection to a water supply configured to supply water to the device, and a pump configured to move the water from the water supply within the device. The device further comprises a first heater configured to heat the water from the water supply to a first temperature. The device further comprises a mixing bar configured to heat and mix a test specimen comprising at least a portion of the liquid sample, wherein the mixing bar is configured to be heated when rinsing the mixing bar with at least a portion of the water prior to the mixing bar contacting the test specimen for mixing.

### Example 2

The device of Example 1, wherein the test specimen is contained in a cuvette.

### Example 3

The device of Example 2, wherein the cuvette is made of plastic.

### Example 4

The device of any one or more of Example 2 through Example 3, wherein the cuvette is configured for replacement after a predetermined usage period.

### Example 5

The device of any one or more of Example 1 through Example 4, further comprising a second heater configured to further heat at least a portion of the water at the first temperature to a second temperature.

### Example 6

The device of Example 5, wherein when the mixing bar is configured to be heated when rising the mixing bar with at least a portion of the water prior to the mixing bar contacting the test specimen for mixing, the at least a portion of the water is at the second temperature.

### Example 7

The device of any one or more of Example 1 through Example 6, wherein the second temperature is about 42 degrees Celsius.

### Example 8

The device of any one or more of Example 1 through Example 7, wherein the first temperature is about 28 degrees Celsius.

### Example 9

The device of any one or more of Example 1 through Example 8, further comprising a dry bath configured to heat the test specimen.

### Example 10

The device of Example 9, wherein the test specimen is heated to about 37 degrees Celsius within about 2 minutes of being exposed to the dry bath and the mixing bar.

### Example 11

The device of any one or more of Example 1 through Example 9, wherein the test specimen is heated to about 37 degrees Celsius within about 2 minutes of being exposed to the mixing bar.

### Example 12

The device of any one or more of Example 2 through Example 11, further comprising a probe assembly configured to transfer a portion of the liquid sample to the cuvette.

### Example 13

The device of any one or more of Example 1 through Example 12, wherein the test specimen comprises a mixture of a portion of the liquid sample, a reagent, and a diluent.

### Example 14

A device for analyzing a test specimen to determine at least one parameter of a liquid sample of the test specimen comprises a body having a sample station and an analysis station disposed within the body. The sample station is configured to receive a container holding the liquid sample. The analysis station is configured to analyze the test specimen within a cuvette. The device further comprises a probe assembly configured to transfer at least a portion of the liquid sample from the container to the cuvette, wherein the contents of the cuvette define the test specimen. The device further comprises a mixing bar configured to contact and mix the test specimen within the cuvette. The device further comprises a heat source configured to heat the mixing bar to a temperature exceeding a temperature of the test specimen such that the mixing bar is further configured to heat the test specimen within the cuvette to a predetermined temperature at which analysis of the test specimen is conducted to determine the at least one parameter of the liquid sample.

### Example 15

The device of Example 14, wherein the heat source comprises a heated water supply that contacts the mixing bar prior to the mixing bar contacting the test specimen.

### Example 16

The device of Example 14, wherein the heat source comprises a heated air supply that contacts the mixing bar prior to the mixing bar contacting the test specimen.

### Example 17

The device of Example 14, wherein the heat source comprises electric resistance heating wherein the mixing bar is connected to an electrical current configured for heating the mixing bar.

### Example 18

The device of any one or more of Example 14 through Example 17, wherein the test specimen is heated to about 37 degrees Celsius within about 2 minutes.

### Example 19

The device of any one or more of Example 14 through Example 18, wherein the cuvette is made of plastic.

### Example 20

A method of preparing a liquid sample for analysis in a device for determining at least one parameter of the liquid sample comprises (a) loading the liquid sample within a sample container into a sample station of the device, (b) transferring at least a portion of the liquid sample from the sample container to a cuvette, wherein the contents of the cuvette comprise the test specimen, (c) heating a mixing bar of the device, configured to mix the test specimen, by exposing the mixing bar to a heat source of the device, (d) positioning the mixing bar to contact the test specimen within the cuvette, wherein contact of the mixing bar with the test specimen is operable to heat the test specimen, (e) removing the mixing bar from contact with the test specimen within the cuvette, and (f) analyzing the test specimen within an analysis station of the device to determine the at least one parameter of the liquid sample of the test specimen, wherein the analysis occurs when the test specimen is substantially at the predetermined temperature.

### Example 21

The method of Example 20, wherein the act of heating the mixing bar comprises rinsing the mixing bar with a heated water supply at about 42 degrees Celsius.

### Example 22

The method of any one or more of Example 20 through Example 21, wherein the cuvette is made of plastic, and wherein the test specimen is heated to the predetermined temperature in about 2 minutes.

### Example 23

The method of any one or more of Example 20 through Example 22, wherein the mixing bar is removed from contact with the test specimen within the cuvette when a predetermined temperature of the test specimen is reached.

### V. MISCELLANEOUS

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

As used herein, the terms “about” or “approximately” for any numerical values or ranges indicates a suitable tolerance that allows for the components related to the numerical values to function for their intended purpose as described herein. More specifically, “about” or “approximately” may refer to the range of values ±10% of the recited value, e.g. “about 90%” may refer to the range of values from 81% to 99%.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A device for determining at least one parameter of a liquid sample, the device comprising:
(a) a body having a sample station and an analysis station disposed within the body, the sample station configured to receive at least a container holding the liquid sample;
(b) a connection to a water supply configured to supply water to the device;
(c) a pump configured to move the water from the water supply within the device;
(d) a first heater configured to heat the water from the water supply to a first temperature; and
(e) a mixing bar configured to heat and mix a test specimen comprising at least a portion of the liquid sample, wherein the mixing bar is configured to be heated when rinsing the mixing bar with at least a portion of the water prior to the mixing bar contacting the test specimen for mixing.

2. The device of claim 1, wherein the test specimen is contained in a cuvette.

3. The device of claim 2, wherein the cuvette is made of plastic.

4. The device of claim 3, wherein the cuvette is configured for replacement after a predetermined usage period.

5. The device of claim 1, further comprising a second heater configured to further heat at least a portion of the water being heated to the first temperature to a second temperature.

6. The device of claim 5, wherein when the mixing bar is configured to be heated when rising the mixing bar with at least a portion of the water prior to the mixing bar contacting the test specimen for mixing, the at least a portion of the water is at the second temperature.

7. The device of claim 5, wherein the second temperature is about 42 degrees Celsius.

8. The device of claim 1, wherein the first temperature is about 28 degrees Celsius.

9. The device of claim 1, further comprising a dry bath configured to heat the test specimen.

10. (canceled)

11. (canceled)

12. The device of claim 2, further comprising a probe assembly configured to transfer a portion of the liquid sample to the cuvette.

13. The device of claim 1, wherein the test specimen comprises a mixture of a portion of the liquid sample, a reagent, and a diluent.

14. A device for analyzing a test specimen to determine at least one parameter of a liquid sample of the test specimen, the device comprising:
(a) a body having a sample station and an analysis station disposed within the body, the sample station configured to receive a container holding the liquid sample, the analysis station configured to analyze the test specimen within a cuvette;
(b) a probe assembly configured to transfer at least a portion of the liquid sample from the container to the cuvette, wherein the contents of the cuvette define the test specimen;
(c) a mixing bar configured to contact and mix the test specimen within the cuvette; and
(d) a heat source configured to heat the mixing bar to a temperature exceeding a temperature of the test specimen such that the mixing bar is further configured to heat the test specimen within the cuvette to a predetermined temperature at which analysis of the test specimen is conducted to determine the at least one parameter of the liquid sample.

15. The device of claim 14, wherein the heat source comprises a heated water supply that contacts the mixing bar prior to the mixing bar contacting the test specimen.

16. The device of claim 14, wherein the heat source comprises a heated air supply that contacts the mixing bar prior to the mixing bar contacting the test specimen.

17. The device of claim 14, wherein the heat source comprises electric resistance heating wherein the mixing bar is connected to an electrical current configured for heating the mixing bar.

18. (canceled)

19. The device of claim 14, wherein the cuvette is made of plastic.

20. A method of preparing a liquid sample for analysis in a device for determining at least one parameter of the liquid sample, the method comprising:
(a) loading the liquid sample within a sample container into a sample station of the device;
(b) transferring at least a portion of the liquid sample from the sample container to a cuvette, wherein the contents of the cuvette comprise the test specimen;
(c) heating a mixing bar of the device, configured to mix the test specimen, by exposing the mixing bar to a heat source of the device;
(d) positioning the mixing bar to contact the test specimen within the cuvette, wherein contact of the mixing bar with the test specimen is operable to heat the test specimen;
(e) removing the mixing bar from contact with the test specimen within the cuvette; and
(f) analyzing the test specimen within an analysis station of the device to determine the at least one parameter of the liquid sample of the test specimen, wherein the analysis occurs when the test specimen is substantially at the predetermined temperature.

21. The method of claim 20, wherein the act of heating the mixing bar comprises rinsing the mixing bar with a heated water supply at about 42 degrees Celsius.

22. The method of claim 20, wherein the cuvette is made of plastic, and wherein the test specimen is heated to the predetermined temperature in about 2 minutes.

23. The method of claim 20, wherein the mixing bar is removed from contact with the test specimen within the cuvette when a predetermined temperature of the test specimen is reached.
